(19) United States
(12) Patent Application Publication
(10) Pub. No.: US 2026/0202232 A1
(43) Pub. Date: Jul. 16, 2026

(54) RESERVOIR WITH OIL LEVEL PROBE

(71) Applicant: SAFRAN AERO BOOSTERS, Herstal (BE)

(72) Inventor: Quentin BORLON, Herstal (BE)

(21) Appl. No.: 19/135,516

(22) PCT Filed: Nov. 2, 2023
(86) PCT No.: PCT/EP2023/080559

§ 371 Date: Jun. 4, 2025

(30) Foreign Application Priority Data
Dec. 5, 2022 (BE) 2022/5987

(51) Int. Cl. G01F 23/263; F01D 21/00; F01D 25/18

(52) U.S. Cl. CPC G01F 23/268; F01D 21/003; F01D 25/18

(57) ABSTRACT

An oil tank for a turbomachine provided with a probe for measuring the oil level. The probe may be a capacitive electrical probe, introduced into the tank so as to be arched. A sleeve encircles lamellar electrodes of the probe to guide the probe during its mounting in the tank and to hold the electrodes in position.

A method of mounting the probe in a tank.

### TECHNICAL FIELD

The invention relates to measuring the level of liquid, and in particular oil, in a turbomachine tank. The invention also relates to a turbomachine, in particular an aircraft turbojet or an aircraft turboprop. The invention further relates to a method for mounting a measuring probe in a tank.

### PRIOR ART

In turbomachines, the liquid tanks and in particular the oil tanks generally have an arcuate shape, embracing the curvature of the turbomachine, in particular in order to limit the size of the turbomachine.

Measuring the oil level in a tank can involve different technologies, including capacitive or resistive probes, measuring variations in capacitance or electrical resistance in the tank and deducting the quantity of oil.

While a slightly curved tank can accommodate straight measuring probes, this is not the case for a tank with a small radius of curvature: straight probes inserted into a highly curved tank would touch the inner wall of the tank. This would create an electrical contact that would disrupt the measurement. Also, a straight probe does not penetrate far enough to the bottom of the tank and is therefore unable to deliver values when the level is particularly low.

Thus, it is known, in particular from document EP 3 399 164 B1, to provide an arcuate probe according to the general curvature of the tank. The probe is received in a sheath or in a plurality of supports which thus impose its arcuate shape on it. This design has certain limitations, in particular in terms of protection of the probe during its insertion into the tank, because the sheath or the supports can affect the space between the electrodes, or even damage the electrodes. Also, this design is unsuitable for single-piece tanks produced by additive manufacturing, because the supports or the sheath which are parts in contact with the probe cannot be metallic.

### DISCLOSURE OF THE INVENTION

### Technical Problem

The invention aims to solve at least one of the problems posed by the prior art. More specifically, the invention aims to propose a lightweight design in which the assembly and disassembly of the oil level measuring probe are facilitated and in which it is ensured that even for significant tank curvatures, the measurement accuracy is not deteriorated.

### Technical Solution

The invention relates to an oil tank for a turbomachine comprising: a generally curved wall; an electric oil level measuring probe, the probe having one or more arcuate lamellar electrode(s) following the curvature of the wall; and at least one sleeve, remarkable in that the sleeve is fitted onto the lamellar electrode(s) so as to interpose between the electrode(s) and the wall, and in that the sleeve is fixed to the probe while being free of fixation with the wall.

Thus, the sleeve(s) prevent the electrodes from directly touching the tank, which is advantageous both to avoid any damage to the electrodes, to prevent their contact with metal parts, and to ensure proper positioning of the electrodes.

According to an advantageous embodiment of the invention, the sleeve is oblong in shape having a longitudinal axis that is transverse to the lamellar electrode(s). Such an arrangement allows good compactness and the fact that the sleeve has a longitudinal direction perpendicular to the electrodes prevents twisting of the electrodes.

According to an advantageous embodiment of the invention, the sleeve includes internal notches accommodating the lamellar electrode(s). It is thus possible to precisely position the lamellar electrodes in the tank. Measurement accuracy is thus guaranteed: indeed, if the electrodes move in the tank during flight, their position no longer corresponds to their initial position (during calibration or calibration).

According to an advantageous embodiment of the invention, the notches are formed by protruding and “V”-shaped tabs. Such a shape allows easier placement of the lamellae in the sleeve because the lamellae are clamped in the notches and it is therefore easier to fix the lamellae to the sleeve. The elasticity of the tabs also contributes to the proper maintenance of the electrodes in position.

According to an advantageous embodiment of the invention, the sleeve includes a through internal cavity entirely occupied by the lamellar electrode(s) and by a wedge.

This not only allows the lamella to be well maintained in position but also prevents oil from penetrating and getting stuck in the sleeve.

According to an advantageous embodiment of the invention, the sleeve has a generally oblong shape with two opposite ends in spherical portions. This shape facilitates the penetration of the probe with the sleeve into the tank and prevents the sleeve from damaging the tank walls. Also, the absence of sharp edges on the sleeve prevents scratching the tank wall and generating particles that would spread into the oil.

According to an advantageous embodiment of the invention, the sleeve is fixed to the probe by means of a pin, a rivet, or a screw element, engaged in a hole of exactly one of the electrode(s). When there are multiple electrodes, a fixation to a single electrode is sufficient and avoids overly constraining the electrodes. Alternatively, several fixation means can be provided to fix each electrode to the sleeve.

According to an advantageous embodiment of the invention, the tank comprises several sleeves and the wall has a non-constant curvature, the sleeves being irregularly distributed along the probe, the sleeves being further apart from each other as the curvature of the wall increases. This avoids zones of accumulation of bending stresses and thus smooths the bending stresses progressively on the probe. Consequently, damage to the probe is avoided and measurement accuracy is guaranteed. Alternatively, the curvature is constant and the sleeves are regularly spaced along the probe. The sleeves can be distributed over the majority or substantially the entire length of the probe.

According to an advantageous embodiment of the invention, the wall is a wall of an arched sheath, preferably formed of two facing U-shaped profiles connected by a mesh. Thus, the sleeve can come into contact with the U, with a slight assembly play. The mesh allows the oil to flow and thus prevents the accumulation of oil in the sleeve or in the sheath. Alternatively or additionally, the sheath can be the one described in document EP 3 399 164 B1, i.e., an articulated sheath. The sheath can extend over the majority or substantially the entire length of the probe. It can extend over the majority or substantially the entire length of the tank. Alternatively, the wall in contact with the sleeve is an internal wall of the tank.

According to an advantageous embodiment of the invention, the sleeve is made of electrically insulating material. This allows the tank and particularly the wall in contact with the sleeve to be made of metallic material, as there will be no electrical contact disturbing the electrodes that could impact the accuracy of the oil level measurement.

The invention also relates to a turbomachine equipped with such a tank. The turbomachine can be mounted on an aircraft capable of performing flight phases known as “negative g”.

The invention also relates to a method for assembling an electric oil level measuring probe in a curved tank of a turbomachine, the method comprising the following steps: (a) fixing one or more sleeve(s) to one or more lamellar electrode(s) of the probe; and (b) introducing the electrode(s) with the sleeve(s) into the tank.

According to an advantageous embodiment of the invention, during the fixing step, the electrode(s) is/are straight, and during the introduction step, the electrode(s) is/are progressively arched due to the contact of the sleeve(s) with a wall of the tank.

According to an advantageous embodiment of the invention, during the fixing step, the electrode(s) is/are arched with a constant or non-constant curvature, and during the introduction step, the electrode(s) maintain(s) its/their curvature.

According to an advantageous embodiment of the invention, the tank comprises an opening, notably an upper filling opening, and during the introduction step, the electrode(s) is/are introduced via said opening.

It is understood that each detail of an embodiment below can be combined with each other detail of the other embodiments.

### BRIEF DESCRIPTION OF THE DRAWINGS

FIG. 1 represents a turbomachine according to the invention;

FIG. 2 illustrates a reservoir according to the invention;

FIG. 3 shows a portion of the sheath;

FIG. 4 and FIG. 5 sketch a capacitive probe and associated sleeve;

FIG. 6 and FIG. 7 show a resistive probe and associated sleeve.

### DETAILED DESCRIPTION

FIG. 1 represents a simplified view of an axial turbomachine. In this specific case, it is a double-flow turbojet engine suitable for aircraft flight.

The turbojet 2 comprises a low-pressure compressor 4, a high-pressure compressor 6, a combustion chamber 8 and one or more levels of turbines 10. In operation, the mechanical power of the turbines 10 transmitted to the rotor 12 sets the two compressors 4 and 6 in motion. The rotation of the rotor around its axis of rotation 14 thus makes it possible to generate an air flow and to gradually compress the latter until it enters the combustion chamber 8.

An inlet fan commonly referred to as a fan or blower 16 is coupled to the rotor 12 and generates an air flow which is divided into a primary flow 18 passing through the compressors and a secondary flow 20. A reducer 22 can reduce the rotation speed of the blower 16 and/or the low pressure compressor 4 relative to the associated turbine level 10. The reducer 22, as well as transmission shafts 24 articulated by bearings 26, are lubricated by an oil circuit. Pumps 28 ensure the circulation of the oil in the circuit, from and to a reservoir 30.

The location of the tank 30 is here figurative. In reality it can be mounted on the fan casing, and more preferably inside the stator 32 separating the primary flow 18 from the secondary flow 20, which are respectively channeled by a primary vein and a secondary vein.

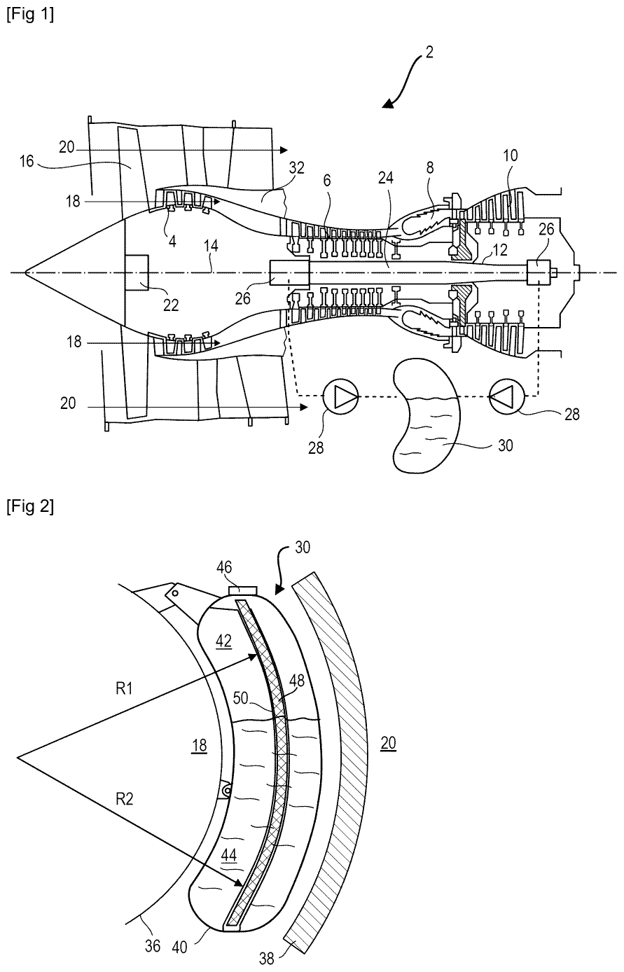

FIG. 2 is a sectional view of an oil reservoir 30 of a turbomachine such as that of FIG. 1. The flows 18 and 20 are represented therein. The reservoir 30 can be housed between a compressor casing 36 and a partition 38 guiding the secondary flow 20.

The tank 30 is generally curved. Its general outline is arched to fit into the circular stator 32 of the turbomachine. Its outer wall 40, or casing, comprises a curved radially inner surface. The height of the tank may be at least 50 cm and it may describe an angular portion of at least 10°. The radius of curvature of the wall 40 may be between 30 cm and 2 m.

The tank 30 comprises a generally closed enclosure 42. The latter can store at least 30 liters of oil 44. The enclosure 42 is also curved. The top of the tank 30 has an opening 46 closed by a plug.

The tank can be metallic and/or can be manufactured by additive manufacturing of the ALM type. It can be single-piece and integrate the fixing brackets and various internal functional elements (baffle, deaerator, etc.).

In order to measure and/or estimate the volume of oil 44 in the tank, a measuring system can be introduced into the tank. This system can comprise an electrical probe 48 immersed in the liquid, and a computer transforming the measured electrical quantity into a value in liters. The probe 48 is arched, for example according to a radius of curvature, constant or not. It follows the curved shape of the tank. The probe 48 extends over the majority or the entire height of the enclosure 42. Thus, it can be in contact with the oil in substantially the entire useful volume of the enclosure 42.

The probe 48 may comprise one or more electrical electrodes coming into electrical contact with the oil. It may be capacitive, in which case it measures the capacitance between two lamellar and parallel electrodes. It may be resistive, in which case it measures the electrical resistance of its immediate environment.

The probe 48 may be immersed in the reservoir 30 or may be inserted into a sheath 50 of the reservoir. The sheath 50 may be metallic and/or manufactured by additive manufacturing together with the reservoir.

The sheath 50 may extend over substantially the entire height of the reservoir 30 and/or the entire length of the probe 48. The sheath 50 may be perforated to facilitate the entry and exit of the oil, in order to come into contact with the probe 48.

The curvature of each of the elements (tank 30, external wall 40, wall of the sheath 50 and probe 48) can be constant or variable. Thus, the notations R1 and R2 in the figure materialize the fact that the curvature can vary for these elements. Each of the elements can have its own curvature independent of the other elements, with the exception of the probe 48 which has a curvature imposed by the wall (wall 40 of the tank or wall of the sheath 50) with which it cooperates.

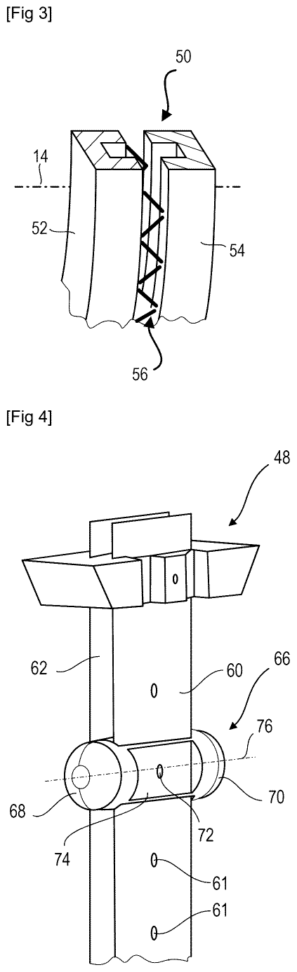

FIG. 3 shows an exemplary embodiment of the sheath 50. In this example, the sheath 50 is made up of two U-shaped rails 52, 54, parallel to each other, facing each other, and connected to each other by a trellis 56.

The U's form indirect contact walls with the probe 48.

FIG. 4 shows a capacitive probe 48. This comprises two lamellar electrodes 60, 62. The electrodes 60, 62 are sufficiently flexible to be bent in flexion during, or before, their placement in the reservoir 30. The electrical capacitance between the electrodes 60, 62 reflects the quantity of liquid separating them and is therefore an image of the oil level in the reservoir. The two electrodes 60, 62 are fixed together by a connector 64 which can be attached to the reservoir at the opening (46 in FIG. 2). The connector is also equipped with electrical connections for connecting the probe to a computer. The reservoir 30 can therefore comprise fixing elements (not shown) for the probe 48 at the opening 46 to immobilize the probe 48 despite the movements of the oil 44 and the vibrations.

At least one of the electrodes (here 60) is provided with orifices 61 allowing the attachment of one or more sleeve(s) 66.

The sleeve 66 encircles the two electrodes 60, 62 while keeping them at a distance from each other.

The sleeve may have two hemispherical ends 68, 70 which may be engaged in the grooves of the U-shaped rails (FIG. 3).

A fixing means 72 (pin, rivet, screw) can ensure the fixing of the sleeve 66 to the electrode 60.

A flat 74 may facilitate fixing or prevent the screw/rivet head from protruding from the sleeve 66. Alternatively, the screw/rivet head may be countersunk in the sleeve 66.

The sleeve 66 may be generally oblong or ovoid in shape, having a longitudinal axis 76 which extends transversely to the length of the electrodes 60, 62.

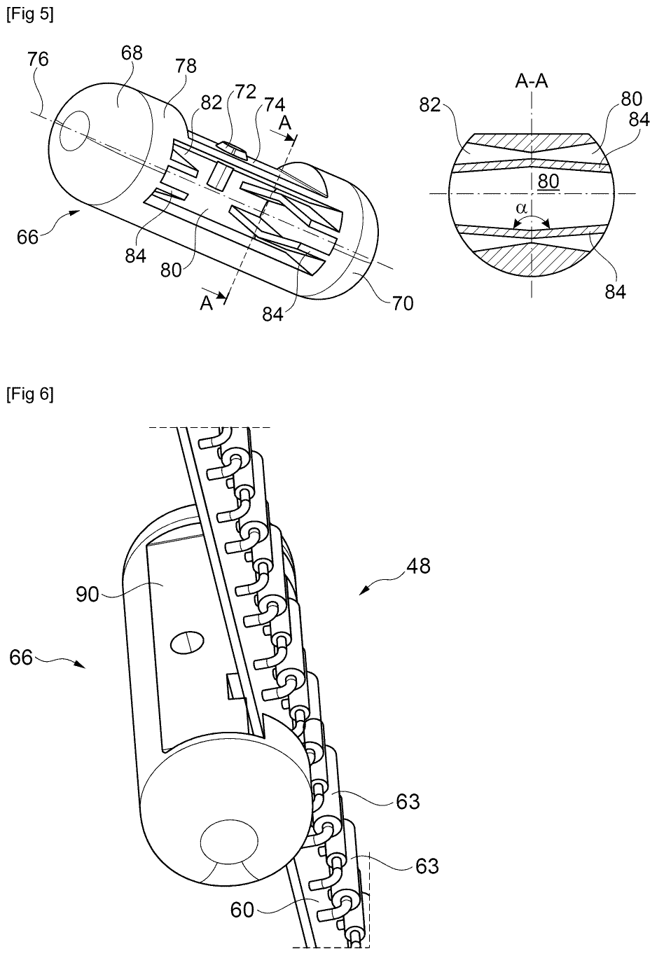

FIG. 5 illustrates the sleeve 66 alone. This is composed of an oblong body, that is to say a cylindrical body 78 with two hemispherical ends 68, 70. The body 78 is hollowed out to receive the electrodes 60, 62 in a through cavity 80.

The cavity 80 may be provided with notches 82 receiving the lamellar electrodes 60, 62. The notches 82 may be the result of tabs 84 projecting internally in the through cavity 80. The tabs 84 may have a “V” shape to facilitate the insertion of the electrodes 60, 62 and/or to give the tabs a certain elasticity allowing the electrodes 60, 62 to be held by wedging.

The tabs 84 may be substantially parallel to the flat 74.

The right-hand part of FIG. 5 shows a diagram of a section in the AA direction identified in the isometric view. It can be seen in particular that an internal surface delimiting the cavity can also have a V-shape facing the tabs 84.

The angle of the V noted a can be between 150 and 170°.

FIG. 6 shows a resistive probe. In this example, the probe 48 comprises a single lamellar electrode 60 provided with resistors 63 distributed along the electrode. The resistors 63 have a common terminal and a free terminal, the circuit being therefore open. The liquid closes the circuit and the liquid level influences the equivalent resistance which is measured.

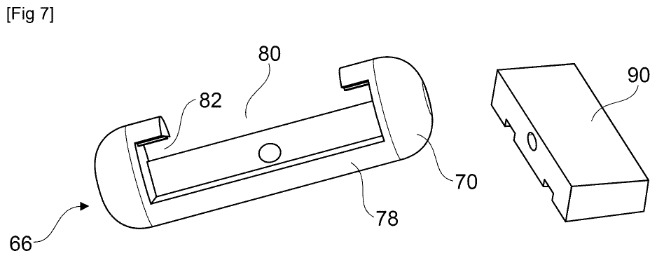

The sleeve 66 may be identical to that used for the capacitive probe of the previous figures. Alternatively, and as drawn in FIGS. 6 and 7, the sleeve 66 may comprise a single notch and a corner 90 filling the through cavity 80.

The wedge 90 may have a shape substantially complementary to the cavity 80. Means of fixing by screw and nut, pin, rivet, etc. may be provided to keep the wedge 90 fixed to the body of the sleeve 66 and thus wedge the electrode 60.

Whether in the case of a capacitive electrode (FIGS. 4 and 5) or resistive electrode (FIGS. 6 and 7), several sleeves 66 can be arranged along the electrodes. For example, when the radius of curvature is small, the sleeves will be closer to each other, in order to smooth the deformation of the electrodes and avoid areas of concentration of bending stresses.

It is understood that a probe may be provided with more than two electrodes, and in particular, the capacitive and resistive electrodes may be combined, one or more sleeves encircling all the electrodes. Also, other probes may be attached to the same sleeve(s), such as for example a temperature probe.

Finally, a corner 90 can be arranged in the example of FIGS. 4 and 5, for example to fill a space left free in the middle of the cavity between the electrodes 60, 62.

The invention also relates to a method of mounting the probe 48. The sleeve(s) 66 are first fixed to one or more lamellar electrodes 60, 62. Then, the assembly is introduced into the reservoir, for example through an opening (type opening 46).

Upon insertion, the electrodes 60, 62 are forced—by contact between the sleeve and the wall 40 or the rails 52, 54—to bend.

Alternatively, the electrodes 60, 62 may be arched before their introduction (with the sleeves 66 attached) into the reservoir 30.

In addition to the advantages mentioned above, the sleeve 66 makes it possible to electrically isolate the electrodes from the tank. A series of sleeves 66 makes it possible to guarantee a constant distance between the electrodes 60, 62, over their entire length. Also, the rounded shapes of the sleeve 66 prevent stagnation or blockage of the liquid which can easily flow around or inside the sleeve 66 and the electrodes 60, 62.

It should be noted that the invention is presented in relation to an oil tank for a turbomachine, but those skilled in the art will understand that the invention also relates to any other liquid and any other type of tank (for example, water, fuel, liquid hydrogen, etc.).

1. An oil tank for a turbomachine, comprising:
a generally curved wall;
an electrical oil level measurement probe, the electrical oil level measurement probe including one or more arcuate lamellar electrodes following a curvature of the curved wall; and
at least one sleeve,
wherein the at least one sleeve is fitted onto the one or more arcuate lamellar electrodes so as to be interposed between the one or more arcuate lamellar electrodes and the curved wall, and in that the at least one sleeve is fixed to the electrical oil level measurement probe while being free of attachment to the curved wall.

2. The tank according to claim 1, wherein the at least one sleeve is oblong in shape defining a longitudinal axis that is transverse to the one or more arcuate lamellar electrodes.

3. The tank according to claim 1, wherein the at least one sleeve defines internal notches accommodating the one or more lamellar electrodes.

4. The tank according to the claim 3, wherein the internal notches are formed by protruding and V-shaped tabs.

5. The tank according to claim 1, wherein the at least one sleeve defines a through internal cavity entirely occupied by the one or more arcuate lamellar electrodes and by a wedge.

6. The tank according to claim 1, wherein the at least one sleeve has a generally oblong shape with two opposite ends in spherical portions.

7. The tank according to claim 1, wherein the at least one sleeve is fixed to the electrical oil level measurement probe by at least one of a pin, a rivet, and a screw element, engaged in a hole of exactly one of the arcuate lamellar electrodes.

8. The tank according to claim 1, further comprising several sleeves and in that the curved wall has a non-constant curvature, the sleeves being irregularly distributed along the electrical oil level measurement probe, the sleeves being spaced further apart from each other as the curvature of the curved wall increases.

9. The tank according to claim 1, wherein the curved wall is a wall of an arcuate sheath, formed of two U-shaped profiles facing each other and connected by a mesh.

10. The tank according to claim 1, wherein at least one sleeve is made of electrically insulating material.

11. The turbomachine for the aircraft comprising:
the oil tank of claim 1.

12. A method for mounting an electrical oil level measurement probe in a curved tank of a turbomachine, the method comprising the following steps:
fixing one or more sleeves to one or more lamellar electrodes of the electrical oil level measurement probe; and
introducing the one or more lamellar electrodes with the one or more sleeves into the curved tank.

13. The method according to claim 12, wherein at the fixing step, the one or more lamellar electrodes are straight, and during the introduction step, the one or more lamellar electrodes are progressively arched due to contact of the one or more sleeves with a wall of the curved tank.

14. The method according to claim 12, wherein at the fixing step, the one or more lamellar electrodes are arched according to a constant or non-constant curvature, and during the introduction step, the one or more lamellar electrodes maintain their curvature.

15. The method according to claim 12, wherein the curved tank comprises an upper filling opening, and during the introduction step, the one or more lamellar electrodes are introduced via said upper filling opening.
